(19) United States
(12) Patent Application Publication
(10) Pub. No.: US 2017/0337005 A1
(43) Pub. Date: Nov. 23, 2017

(54) CONTROL BOARD AND METHOD FOR CONTROLLING THE SAME

(71) Applicants: Inventec (Pudong) Technology Corporation, Shanghai (CN); INVENTEC CORPORATION, Taipei City (TW)

(72) Inventor: Shi-Jie HONG, Shanghai (CN)

(21) Appl. No.: 15/234,411

(22) Filed: Aug. 11, 2016

(30) Foreign Application Priority Data
May 23, 2016 (CN) 201610345456.0

(51) Int. Cl. G06F 3/06; G06F 13/40

(52) U.S. Cl. CPC G06F 3/0631; G06F 13/4068; G06F 3/0604; G06F 3/0685

(57) ABSTRACT

A control board includes a storage module and a control module. The storage module includes a configured memory space and a non-configured memory space. The non-configured memory space further has at least one first storage unit, and each of the at least one first storage unit stores a first configuration document. The control module connected with the storage module switches to load the first configuration document under a control of a switch instruction by referring to a first mapping table, and bases on the first configuration document after the switching to allot a plurality of hard disk drives of a disk drive group connected with the control board to corresponding communication ports of the control module. Thus, access permission can be set in a physical layer of the expander board through at least one configuration document, and a certain number of storage units are allotted to store the configuration document.

### BACKGROUND OF INVENTION

### 1. FIELD OF THE INVENTION

The invention relates to a control method for hard disk drives in the field of storage technology, and more particularly to a control board and a method for controlling the control board.

### 2. DESCRIPTION OF THE PRIOR ART

The JBOD (Just a bunch of disks) is one of important storage apparatuses in the storage field. The JBOD, also called as a Span, is well known to have a plurality of hard disk drives mounted on a base board. Different to the RAID (Redundant array of independent disks), the JBOD does not have front-end logics to manage data allotments over respective hard disks. Alternatively, each hard disk of the JBOD performs individual addressing. As a separate storage resource, an application part for the main-board software, or an adapter card of the RAID unit, though the JBOD can't be deemed as a standard RAID but only a storage device proposed by some manufacturers, it is still widely accepted.

Currently, to meet various clients' demands, a configuration document of an expander is usually introduced to allot an accessible HDD (Hard disk drive) to each uploaded SAS (Serial attached SCSI) port of a SIM card (or a control board). Such a configuration resort may meet a single demand upon a fixed apparatus, but the configuration document of the expander needs to be re-configured, burned and then tested if any change is made.

### SUMMARY OF THE INVENTION

Accordingly, it is the primary object of the present invention to provide a control board and a method for controlling the control board that can be used to resolve the aforesaid problem in re-configuring the configuration document of the JBOD structure while any change is met, such that better flexibility thereof can be obtained.

In the present invention, the control board includes a storage module and a control module. The storage module further includes a configured memory space and a non-configured memory space. The non-configured memory space further has at least one first storage unit, and each of the at least one first storage unit stores a first configuration document. The control module connected with the storage module switches to load the first configuration document under a control of a switch instruction by referring to a first mapping table, and bases on the first configuration document after the switching to allot a plurality of hard disk drives of a disk drive group connected with the control board to corresponding communication ports of the control module.

In one embodiment of the present invention, the first mapping table includes a one-to-one position mapping relationship between a content of the switch instruction and the at least one first storage unit.

In one embodiment of the present invention, each of the at least one first storage unit has only one identification information, the switch instruction includes an instruction parameter, and a type of the instruction parameter and the identification information of the first storage unit form a one-to-one mapping relationship.

In one embodiment of the present invention, the control module stores the instruction parameter into an EEPROM (Electrically-erasable programmable read-only memory). While in re-activating the control module, the control module bases on the type of the instruction parameter stored in the EEPROM to load the corresponding first configuration document in the first storage unit, in which the EEPROM is constructed either inside or outside of the control board.

In one embodiment of the present invention, the communication port of the control module is communicatively connected to a corresponding host. After the switching of the first configuration document of the disk drive group is effective, the hard disk drive is allotted to the corresponding host according to the first configuration document.

In one embodiment of the present invention, the first configuration document is different from one of the at least one first storage unit to another one of the at least one first storage unit.

In one embodiment of the present invention, the configured memory space has a second storage unit for storing a second configuration document of the disk drive group.

In one embodiment of the present invention, the first mapping table further includes a one-to-one position mapping relationship between a content of the switch instruction and the second storage unit, and the instruction parameter of the switch instruction further includes a corresponding type of identification information of the second storage unit.

In another aspect of the present invention, the control method applicable to the aforesaid control board includes: a step (a) of constructing the at least one first storage unit in the non-configured memory space of the storage module, the at least on storage unit being used to store the first configuration document of the disk drive group; and, a step (b) of, under a control of the switch instruction, basing on the first mapping table to switch and thus load the first configuration document, such that each of hard disk drives of the disk drive group is allotted to a corresponding communication port of the control module according to the switched first configuration document.

In one embodiment of the present invention, the first mapping table includes a one-to-one position mapping relationship between a content of the switch instruction and the at least one first storage unit.

In one embodiment of the present invention, each of the at least one first storage unit has only one identification information, the switch instruction includes an instruction parameter, and a type of the instruction parameter and the identification information of the first storage unit form a one-to-one mapping relationship. Under the control of the switch instruction, the switching to load the corresponding first configuration document of the first storage unit includes a step of storing the instruction parameter of the switch instruction into an EEPROM, and a step of, while in re-activating the control module, basing on the type of the instruction parameter stored in the EEPROM to load the corresponding first configuration document in the first storage unit.

In one embodiment of the present invention, the allotting of the hard disk drives of the disk drive group according to the switched first configuration document includes a step of communicating a communication port connected with a corresponding host, and a step of, after the switched first configuration document of the disk drive group is effective, re-allotting each of the hard disk drives of the disk drive group to the corresponding host according to the switched first configuration document.

In one embodiment of the present invention, the first configuration document is different from one of the at least one first storage unit to another one of the at least one first storage unit.

In one embodiment of the present invention, the configured memory space has a second storage unit for storing a second configuration document of the disk drive group.

In one embodiment of the present invention, the first mapping table further includes a one-to-one position mapping relationship between a content of the switch instruction and the second storage unit, and the instruction parameter of the switch instruction further includes a corresponding type of identification information of the second storage unit.

As stated, the control board and the control method for the control board in accordance with the present invention have the following obvious advantages over the conventional design. By providing the present invention to reset the access permission of the physical layer of the expander board through switching the configuration documents, by allotting a certain number of storage units to store these configuration documents, and if client's demand is changed, then an re-allotment of the HDDs in the JBOD to different hosts can be executed upon an instruction to switch the configuration document. Thus, in the case that client's demand varies slightly, only the instruction to switch the configuration document is needed. Hence, re-configuring, burning and testing the configuration document are not required anymore, thus the development cost can be saved, and consequently the efficiency can be substantially increased.

All these objects are achieved by the control board and the method for controlling the control board described below.

### BRIEF DESCRIPTION OF THE DRAWINGS

The present invention will now be specified with reference to its preferred embodiment illustrated in the drawings, in which:

FIG. 1 is a schematic block view of a preferred embodiment of the control board in accordance with the present invention;

FIG. 2 is a schematic block view of the storage module of FIG. 1;

FIG. 3 is a flowchart for operating the control module of

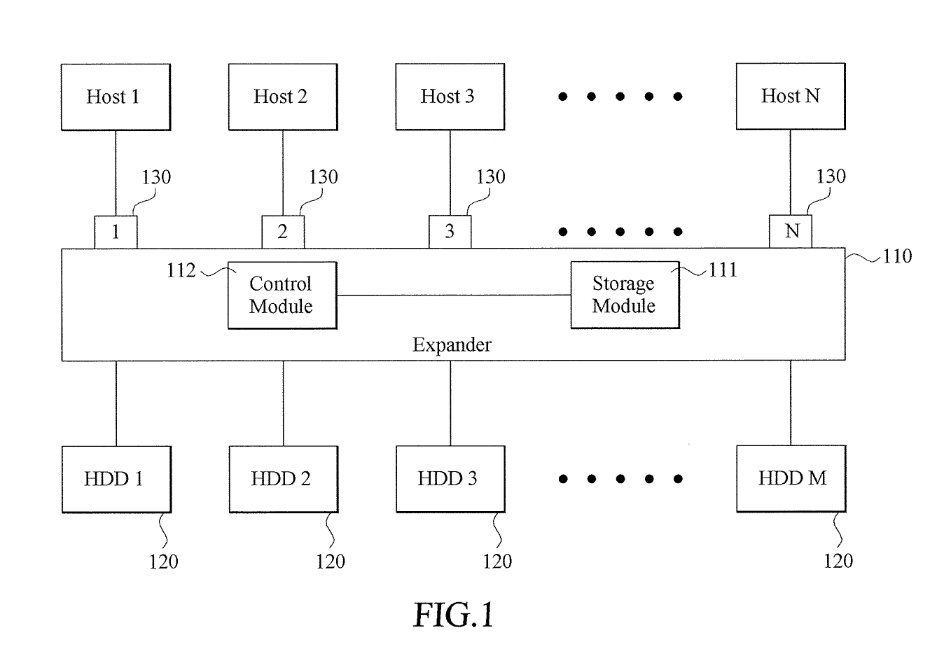

FIG. 1;

FIG. 4 is a flowchart of a preferred method for controlling the control board of FIG. 1;

FIG. 5A is a flowchart for switching to load the configuration document of FIG. 4;

FIG. 5B is another flowchart for switching to load the configuration document of FIG. 4; and

FIG. 6 is a flowchart of allotting hard disk drives of FIG. 4.

### DESCRIPTION OF THE PREFERRED EMBODIMENT

The invention disclosed herein is directed to a control board and a method for controlling the control board. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

It shall be noted firstly that, in the following drawings of the corresponding embodiments, any term provided is only led to concisely elucidate the concept of the present invention in a schematic way. Thus, components or number of any component therein is only one of the exemplary examples in accordance with the present invention. In practice, the component arrangement, the number of each component, the shape of each component or the dimension of each component for any other embodiment shall meet changes if any difference exists in between with any following drawing of the corresponding embodiment.

Referring now to FIG. 1, a schematic block view of a preferred embodiment of the control board in accordance with the present invention is shown. The control board 110 as shown includes a storage module 111 and a control module 112. A host of the control board 110 applies communication ports 130 to access different hard disk drives (HDD) 120. The storage module 111 includes at least one configured memory space and one non-configured memory space. The non-configured memory space further includes at least one first storage unit. Each of the first storage units is to store a first configuration document, and the first configuration document may be varied to different first storage units. The configured memory space further includes at least one second storage unit for storing the second configuration document of the disk drive group.

As shown, the control module 112 is connected with the storage module 111. With a switch instruction, the control module 112 can switch to load a corresponding configuration document according to a first mapping table, such that the control module 112 can base on the switched configuration document to allot each of the hard disk drives of the disk drive group connected with the control board 110 to the corresponding communication port in the control module 112. In the first mapping table, the storage unit, the configuration document and switch instruction are formatted to a one-to-one relationship.

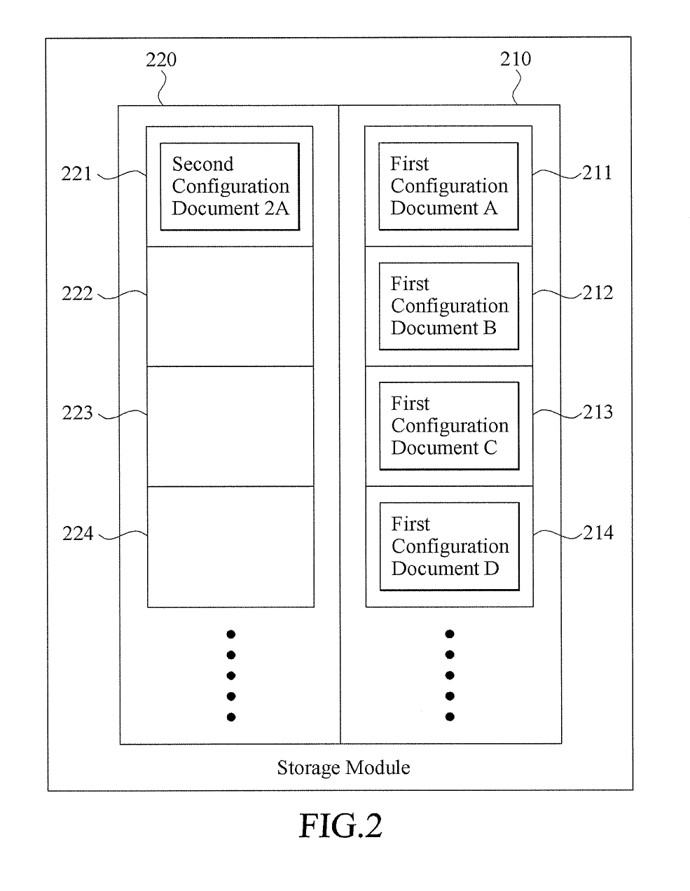

Referring now to FIG. 2, a schematic block view of the storage module of FIG. 1 is shown. In the non-configured memory space 210 of the storage module 111, a first storage unit A 211, a first storage unit B 212, a first storage unit C 213, a first storage unit D 214 and so on are constructed. As shown, the first storage unit A stores a first configuration document A, the first storage unit B stores a first configuration document B, the first storage unit C stores a first configuration document C, and the first storage unit D stores a first configuration document D.

The first configuration document A, the first configuration document B, the first configuration document C, and the first configuration document D can have different contents. In the configured memory space 220 of the storage module 111, a second storage unit 2A 221 is constructed to store a second configuration document 2A of the disk drive group. Also in the configured memory space 220 of the storage module 111, other types of information can be stored into a third storage unit 3A 222, a fourth storage unit 4A 223, a fifth storage unit 5A 224, and so on.

The first mapping table includes contents of the switch instruction and the one-to-one position mapping relationship of the first storage unit.

Practically, one of the embodied formats for the first mapping table can be that each individual first storage unit has only one identification information, in which the identification information can be address information, an encoded number, or an arbitrary type of identifiers. For example, referring to the following Table 1a, the identification information of the first storage unit A is the corresponding MAC address (Media access control address) or the encoded number Flash OEM 1, the identification information of the first storage unit B is the corresponding MAC address or the encoded number Flash OEM 2, the identification information of the first storage unit C is the corresponding MAC address or the encoded number Flash OEM 3, and the identification information of the first storage unit D is the corresponding MAC address or the encoded number Flash OEM 4.

The switch instruction includes instruction parameters. A one-to-one mapping relationship is formed between the types of the instruction parameters and the identification information of the corresponding first storage unit. For example, a type A of the instruction parameters is corresponding to the first storage unit A, a type B of the instruction parameters is corresponding to the first storage unit B, a type C of the instruction parameters is corresponding to the first storage unit C, and a type D of the instruction parameters is corresponding to the first storage unit D.

TABLE 1a
A first mapping table

| | Storage unit | | | |
|---|---|---|---|---|
| | 1^{st} storage | | 1^{st} storage | |
| | unit A | 1^{st} storage unit B | unit C | 1^{st} storage unit D |
| Identification | Flash OEM 1 | Flash OEM 2 | Flash OEM 3 | Flash OEM 4 |
| information | | | | |
| Configuration | 1^{st} | 1^{st} | 1^{st} | 1^{st} |
| document | configuration | configuration | configuration | configuration |
| | document A | document B | document C | document D |
| Type of | A | B | C | D |
| instruction | | | | |
| parameters | | | | |

The first mapping table further includes a one-to-one position mapping relationship between the contents of the switch instruction and the second storage unit. Namely, the first mapping table may include the corresponding one-to-one position mapping relationships between the contents of the switch instruction and at least the first storage unit and the second storage unit, respectively.

Practically, one embodied format of the first mapping table is that each individual first storage unit has only one identification information and each individual second storage unit has correspondingly only one identification information. In the present invention, the identification information can be address information, an encoded number, or an arbitrary type of identifiers. For example, referring to the following Table 1b, the identification information of the first storage unit A is the corresponding MAC address (Media access control address) or the encoded number Flash OEM 1, the identification information of the first storage unit B is the corresponding MAC address or the encoded number Flash OEM 2, the identification information of the first storage unit C is the corresponding MAC address or the encoded number Flash OEM 3, the identification information of the first storage unit D is the corresponding MAC address or the encoded number Flash OEM 4, and the identification information of the second storage unit 2A is the corresponding MAC address or the encoded number Flash OEM 5.

The switch instruction includes instruction parameters. The instruction parameters further include the types corresponding to the identification information of the second storage unit. Namely, the types of the instruction parameters and the identification information of the first storage unit and the second storage unit form a one-to-one mapping relationship. For example, a type A of the instruction parameters is corresponding to the first storage unit A, a type B of the instruction parameters is corresponding to the first storage unit B, a type C of the instruction parameters is corresponding to the first storage unit C, a type D of the instruction parameters is corresponding to the first storage unit D, and a type 2A of the instruction parameters is corresponding to the second storage unit 2A.

TABLE 1b
Another first mapping table

| | Storage unit | | | | |
|---|---|---|---|---|---|
| | 1^{st} storage | 1^{st} storage | 1^{st} storage | 1^{st} storage | 2^{nd} storage |
| | unit A | unit B | unit C | unit D | unit 2A |
| Identification | Flash | Flash | Flash | Flash | Flash |
| information | OEM 1 | OEM 2 | OEM 3 | OEM 4 | OEM 5 |
| Configuration | 1^{st} | 1^{st} | 1^{st} | 1^{st} | 2^{nd} |
| document | configuration | configuration | configuration | configuration | configuration |
| | document A | document B | document C | document D | document |
| | | | | | 2A |
| Type of | A | B | C | D | 2A |
| instruction | | | | | |
| parameters | | | | | |

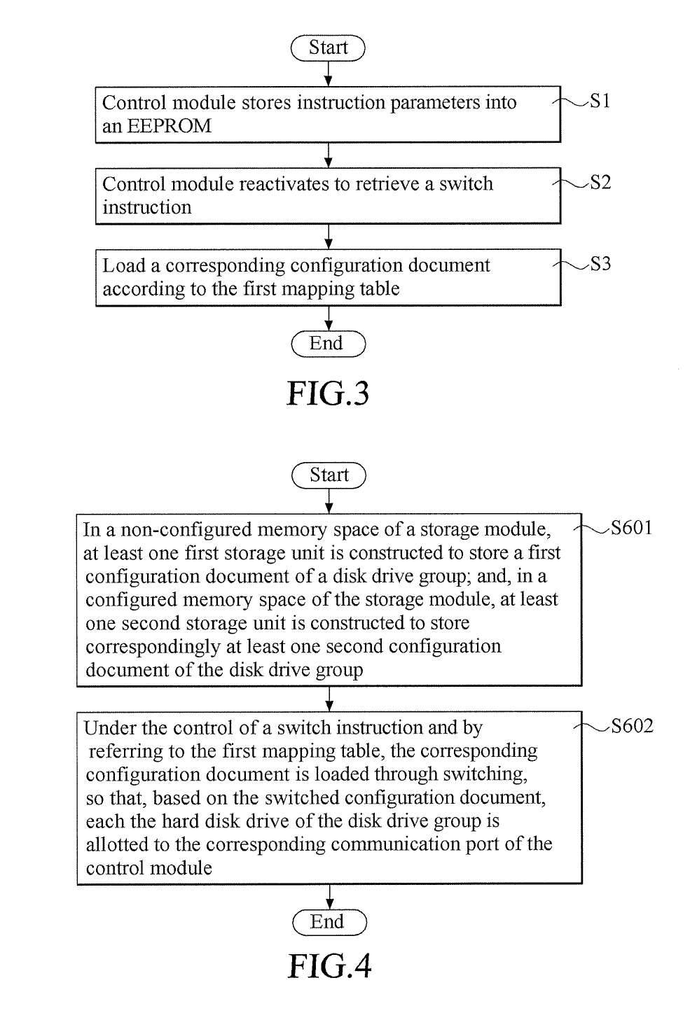

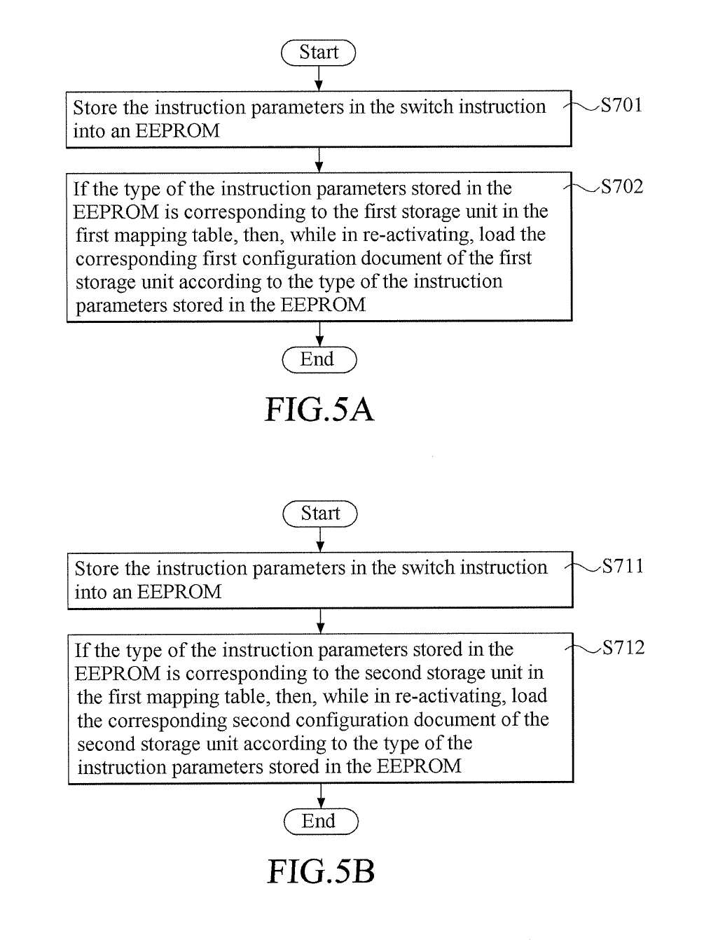

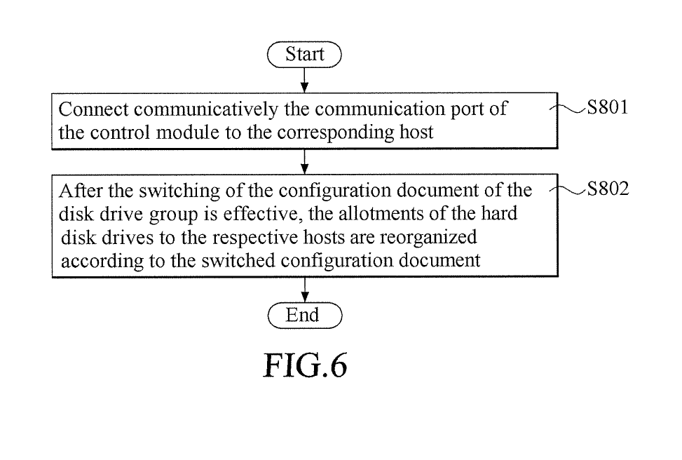

Referring now to FIG. 3, a flowchart for operating the control module of FIG. 1 is shown. The process for the control module 112 controlled by a switch instruction to base on the first mapping table to switch and then load the corresponding configuration document includes the following steps.

Firstly, the control module stores the instruction parameters in the switch instruction into an EEPROM (Step S1), in which the EEPROM can be constructed inside or outside of the control board. Then, the control module reactivates to retrieve the switch instruction (Step S2). If the type of the instruction parameters stored in the EEPROM matches the corresponding first storage unit in the first mapping table, then the activated control module would load the corresponding first configuration document in the first storage unit (Step S3). Namely, if the type of the instruction parameters stored in the EEPROM is the type A (referring to Table 1a and Table 1b), then the activated control module would load the corresponding first configuration document A. If the type of the instruction parameters stored in the EEPROM is the type B (referring to Table 1a and Table 1b), then the activated control module would load the corresponding first configuration document B. If the type of the instruction parameters stored in the EEPROM is the type C (referring to Table 1a and Table 1b), then the activated control module would load the corresponding first configuration document C. If the type of the instruction parameters stored in the EEPROM is the type D (referring to Table 1a and Table 1b), then the activated control module would load the corresponding first configuration document D. If the type of the instruction parameters stored in the EEPROM matches the second storage unit in the first mapping table, then the activated control module would load the corresponding second configuration document in the second storage unit. Namely, if the type of the instruction parameters stored in the EEPROM is the type 2A (referring to Table 1a and Table 1b), then the activated control module would load the corresponding second configuration document 2A.

Referring to FIG. 1, the communication ports 130 of the control module 110 are connected communicatively to the corresponding hosts. After the switching of the configuration document of the disk drive group is effective, the allotments of the hard disk drives to the hosts are reorganized according to the switched configuration document. For example, if the number of the communication ports 130 of the control module 110 is 8 (i.e Ports 1˜8), the number of the corresponding hosts is 8, (i.e. Hosts 1˜8), the number of the first storage units is 3 (i.e. Zones 0˜2), the number of the second storage units is 1 (i.e. Zone 3), and the number of the HDDs is 70 (i.e. Ms 0˜69), then the allotment for each of the first configuration documents in the corresponding first storage units and the second configuration document in the corresponding second storage unit age unit with respect to each of the hard disk drives in the disk drive group can be shown in Table 2.

TABLE 2
Allotment of configuration documents of the
control board with respect to the hard disk drives

| | Port 1 | Port 2 | Port 3 | Port 4 | Port 5 | Port 6 | Port 7 | Port 8 |
|---|---|---|---|---|---|---|---|---|
| Zone 0 | 0-69 | 0-69 | 0-69 | 0-69 | 0-69 | 0-69 | 0-69 | 0-69 |
| Zone 1 | 0-34 | 0-34 | 0-34 | 0-34 | 0-34 | 0-34 | 0-34 | 0-34 |
| Zone 2 | 0-17 | 0-17 | 18-34 | 18-34 | 35-52 | 35-52 | 53-69 | 53-69 |
| Zone 3 | 0-8 | 9-17 | 18-26 | 27-34 | 35-43 | 44-52 | 53-61 | 62-69 |

From the foregoing examples of the present invention, while the updated configuration document is effective, the HDDs in the JBOD would be re-allotted. Then, hosts connecting the corresponding communication ports of the expander board would be able to access the new-allotted HDDs. Thereupon, through simple instructions to switch, various clients' demands can be thus met. By providing the present invention, a simple configurable device can satisfy plenty clients' needs. Hence, the aforesaid problem in inevitable redesign to meet evenly slight changes at the client end can be resolved, thus time for development and testing can be greatly saved, and also production cost can be substantially reduced.

In another aspect of the present invention, a method for controlling the aforesaid control board is provided. However, it shall be noted that the present method, though applicable to the aforesaid control board, is not particularly limited to the control boards as described herein. Actually, any similar or alternative control board structure in accordance with the present invention shall be included within the scope of the present invention.

Referring now to FIG. 4, a flowchart of a preferred method for controlling the control board of FIG. 1 is schematically shown. The control method includes the following steps.

In a non-configured memory space of a storage module, at least one first storage unit is constructed to store a first configuration document of a disk drive group. The first configuration documents stored in the corresponding first storage units may vary. On the other hand, in a configured memory space of the storage module, at least one second storage unit is constructed to store correspondingly at least one second configuration document of the disk drive group (Step S601).

Further, referring to FIG. 2 and FIG. 4, in the non-configured memory space 210 of the storage module, a first storage unit A 211, a first storage unit B 212, a first storage unit C 213, a first storage unit D 214, and so on are included. Correspondingly, the first storage unit A stores a first configuration document A, the first storage unit B stores a first configuration document B, the first storage unit C stores a first configuration document C, and the first storage unit D stores a first configuration document D.

The first configuration document A, the first configuration document B, the first configuration document C and the first configuration document D may have different contents. In the configured memory space 220 of the storage module 111, a second storage unit 2A 221 is included to store a second configuration document 2A of the disk drive group.

Inside the configured memory space 220 of the storage module 111, a third storage unit 3A 222, a fourth storage unit 4A 223, a fifth storage unit 5A 224, and so on can be further included to store other types of information.

Under the control of a switch instruction and by referring to a first mapping table, the corresponding configuration document can be loaded through necessary switching, so that, based on the switched configuration document, each the hard disk drive of the disk drive group can be allotted to the corresponding communication port of the control module (Step S602). In the first mapping table, a one-to-one mapping relationship is shown among the storage units, the configuration documents, and the switch instructions.

The first mapping table includes the one-to-one position mapping relationship between the contents of the switch instructions and the first storage units. Practically, one embodied format for the first mapping table is that each individual first storage unit has only one identification information, in which the identification information can be address information, an encoded number, or an arbitrary type of identifiers. For example, referring to the aforesaid Table 1a, the identification information of the first storage unit A is the corresponding MAC address (Media access control address) or the encoded number Flash OEM 1, the identification information of the first storage unit B is the corresponding MAC address or the encoded number Flash OEM 2, the identification information of the first storage unit C is the corresponding MAC address or the encoded number Flash OEM 3, and the identification information of the first storage unit D is the corresponding MAC address or the encoded number Flash OEM 4.

The switch instruction includes instruction parameters. A one-to-one mapping relationship is formed between the types of the instruction parameters and the identification information of the corresponding first storage unit. For example, a type A of the instruction parameters is corresponding to the first storage unit A, a type B of the instruction parameters is corresponding to the first storage unit B, a type C of the instruction parameters is corresponding to the first storage unit C, and a type D of the instruction parameters is corresponding to the first storage unit D.

The first mapping table further includes a one-to-one position mapping relationship between the contents of the switch instruction and the second storage unit. Namely, the first mapping table may include the corresponding one-to-one position mapping relationships between the contents of the switch instruction and at least the first storage unit and the second storage unit, respectively.

Practically, one embodied format of the first mapping table is that each individual first storage unit has only one identification information and each individual second storage unit has correspondingly only one identification information. In the present invention, the identification information can be address information, an encoded number, or an arbitrary type of identifiers. For example, referring to the aforesaid Table 1b, the identification information of the first storage unit A is the corresponding MAC address (Media access control address) or the encoded number Flash OEM 1, the identification information of the first storage unit B is the corresponding MAC address or the encoded number Flash OEM 2, the identification information of the first storage unit C is the corresponding MAC address or the encoded number Flash OEM 3, the identification information of the first storage unit D is the corresponding MAC address or the encoded number Flash OEM 4, and the identification information of the second storage unit 2A is the corresponding MAC address or the encoded number Flash OEM 5.

The switch instruction includes instruction parameters. The instruction parameters further include the types corresponding to the identification information of the second storage unit. Namely, the types of the instruction parameters and the identification information of the first storage unit and the second storage unit form a one-to-one mapping relationship. For example, a type A of the instruction parameters is corresponding to the first storage unit A, a type B of the instruction parameters is corresponding to the first storage unit B, a type

C of the instruction parameters is corresponding to the first storage unit C, a type D of the instruction parameters is corresponding to the first storage unit D, and a type 2A of the instruction parameters is corresponding to the second storage unit 2A.

Referring now to FIG. 5A, a flowchart for switching to load the configuration document of FIG. 4 is schematically shown. Under the control of a switch instruction and by referring to a first mapping table, the switching to load the corresponding configuration document can include the following steps.

Firstly, the instruction parameters in the switch instruction are stored into an EEPROM (Step S701). If the type of the instruction parameters stored in the EEPROM is corresponding to the first storage unit in the first mapping table, then, while in re-activating, load the corresponding first configuration document of the first storage unit according to the type of the instruction parameters stored in the EEPROM (Step S702).

For example, if the type of the instruction parameters stored in the EEPROM is the type A (referring to Table 1a and Table 1b), then the activated control module would load the corresponding first configuration document A. If the type of the instruction parameters stored in the EEPROM is the type B (referring to Table 1a and Table 1b), then the activated control module would load the corresponding first configuration document B. If the type of the instruction parameters stored in the EEPROM is the type C (referring to Table 1a and Table 1b), then the activated control module would load the corresponding first configuration document C. If the type of the instruction parameters stored in the EEPROM is the type D (referring to Table 1a and Table 1b), then the activated control module would load the corresponding first configuration document D.

Referring now to FIG. 5B, another flowchart for switching to load the configuration document of FIG. 4 is schematically shown. Under the control of a switch instruction and by referring to a first mapping table, another switching to load the corresponding configuration document can include the following steps.

Firstly, the instruction parameters in the switch instruction are stored into an EEPROM (Step S711). If the type of the instruction parameters stored in the EEPROM is corresponding to the second storage unit in the first mapping table, then, while in re-activating, load the corresponding second configuration document of the second storage unit according to the type of the instruction parameters stored in the EEPROM (Step S712). For example, if the type of the instruction parameters stored in the EEPROM is the type 2A (referring to Table 1a and Table 1b), then the activated control module would load the corresponding second configuration document 2A.

Referring now to FIG. 6, a flowchart of allotting hard disk drives of FIG. 4 is schematically shown. According to the switched configuration document, each the hard disk drive of the disk drive group can be allotted to the corresponding communication port of the control module. The allotting method can include the following steps.

The communication port of the control module is communicatively connected to the corresponding host (Step S801). After the switching of the configuration document of the disk drive group is effective, the allotments of the hard disk drives to the respective hosts are reorganized according to the switched configuration document (Step S802). For example, if the number of the communication ports 130 of the control module 110 is 8 (i.e. Ports 1˜8), the number of the corresponding hosts is 8, (i.e. Hosts 1˜8), the number of the first storage units is 3 (i.e. Zones 0˜2), the number of the second storage units is 1 (i.e. Zone 3), and the number of the HDDs is 70 (i.e. Ms 0˜69), then the allotment for each of the first configuration documents in the corresponding first storage units and the second configuration document in the corresponding second storage unit age unit with respect to each of the hard disk drives in the disk drive group can be shown in Table 2.

The scope of the control method in this present invention is not limited to the orders of the steps in the aforesaid embodiments. Any change or replacement in the steps of the method in accordance with the present invention shall be within the scope of the present invention.

It is obvious that the conventional JBOD structure is less flexible, since a specific arrangement can be provided to meet only one demand of the client. If the demand is slightly changed, then the configuration document needs to be re-configured, burned and tested, from which additional labor and cost are inevitable. By providing the present invention to reset the access permission of the physical layer of the expander board through switching the configuration documents, by allotting a certain number of storage units to store these configuration documents, and if client's demand is changed, then an re-allotment of the HDDs in the JBOD to different hosts can be executed upon an instruction to switch the configuration document. Thus, in the case that client's demand varies slightly, only the instruction to switch the configuration document is needed. Hence, re-configuring, burning and testing the configuration document are not required anymore, thus the development cost can be saved, and consequently the efficiency can be substantially increased.

In summary, the present invention overcomes various shortcomings of the conventional design, and thus the value in applicability is obvious.

While the present invention has been particularly shown and described with reference to a preferred embodiment, it will be understood by those skilled in the art that various changes in form and detail may be without departing from the spirit and scope of the present invention.

What is claimed is:

1. A control board, comprising:
a storage module, including a configured memory space and a non-configured memory space, the non-configured memory space further having at least one first storage unit, each of the at least one first storage unit storing a first configuration document; and
a control module, connected with the storage module, switching to load the first configuration document under a control of a switch instruction by referring to a first mapping table, basing on the first configuration document after switching to allot a plurality of hard disk drives of a disk drive group connected with the control board to corresponding communication ports of the control module.

2. The control board of claim 1, wherein the first mapping table includes a one-to-one position mapping relationship between a content of the switch instruction and the at least one first storage unit.

3. The control board of claim 2, wherein each of the at least one first storage unit has only one identification information, the switch instruction includes an instruction parameter, and a type of the instruction parameter and the identification information of the first storage unit form a one-to-one mapping relationship.

4. The control board of claim 3, wherein the control module stores the instruction parameter into an EEPROM (Electrically-erasable programmable read-only memory); wherein, while in re-activating the control module, the control module bases on the type of the instruction parameter stored in the EEPROM to load the corresponding first configuration document in the first storage unit; wherein the EEPROM is constructed either inside or outside of the control board.

5. The control board of claim 1, wherein the communication port of the control module is communicatively connected to a corresponding host; wherein, after the switching of the first configuration document of the disk drive group is effective, the hard disk drive is allotted to the corresponding host according to the first configuration document.

6. The control board of claim 1, wherein the first configuration document is different from one of the at least one first storage unit to another one of the at least one first storage unit.

7. The control board of claim 1, wherein the configured memory space has a second storage unit for storing a second configuration document of the disk drive group.

8. The control board of claim 7, wherein the first mapping table further includes a one-to-one position mapping relationship between a content of the switch instruction and the second storage unit, and the instruction parameter of the switch instruction further includes a corresponding type of identification information of the second storage unit.

9. A control method, applicable to the control board of claim 1, comprising:
Step (a): constructing the at least one first storage unit in the non-configured memory space of the storage module, the at least on storage unit being used to store the first configuration document of the disk drive group; and
Step (b): under a control of the switch instruction, basing on the first mapping table to switch and thus load the first configuration document, such that each of hard disk drives of the disk drive group is allotted to a corresponding communication port of the control module according to the switched first configuration document.

10. The control method of claim 9, wherein the first mapping table includes a one-to-one position mapping relationship between a content of the switch instruction and the at least one first storage unit.

11. The control method of claim 10, wherein each of the at least one first storage unit has only one identification information, the switch instruction includes an instruction parameter, and a type of the instruction parameter and the identification information of the first storage unit form a one-to-one mapping relationship; wherein the Step (b) further includes:
Step (b1) Storing the instruction parameter of the switch instruction into an EEPROM; and
Step (b2) while in re-activating the control module, basing on the type of the instruction parameter stored in the EEPROM to load the corresponding first configuration document in the first storage unit.

12. The control method of claim 10, wherein the Step (b) further includes:
Step (b3) communicating a communication port connected with a corresponding host; and
Step (b4) after the switched first configuration document of the disk drive group is effective, re-allotting each of the hard disk drives of the disk drive group to the corresponding host according to the switched first configuration document.

13. The control method of claim 9, wherein the first configuration document is different from one of the at least one first storage unit to another one of the at least one first storage unit.

14. The control method of claim 9, wherein the configured memory space has a second storage unit for storing a second configuration document of the disk drive group.
